(19) United States
(12) Patent Application Publication
(10) Pub. No.: US 2005/0134008 A1
(43) Pub. Date: Jun. 23, 2005

(54) Gasket having a sealed chamber and method of manufacture

(75) Inventors: Ralf Salameh, Gondelsheim (DE); Gerhard Seibert, Karlsruhe (DE)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: Federal-Mogul Sealing Systems Bretten GmbH & Co. KG

(21) Appl. No.: 11/018,882

(22) Filed: Dec. 20, 2004

(30) Foreign Application Priority Data
Dec. 20, 2003 (DE) 103 60 180.5

(51) Int. Cl. F16J 3/00

(52) U.S. Cl. 277/628

(57) ABSTRACT

Process for creating one or more sealed chambers between flat supporting elements interlinked by studs in a gasket, such that the studs are thinner than the cross-section of the supporting elements and have staggered, facing embossed areas, and such that each of the sealed chambers is situated toward the margins of the supporting elements.

This application claims priority to German Patent Application No. 103 60 180.5, filed Dec. 20, 2003.

### BACKGROUND OF THE INVENTION

1. Technical Field

The invention concerns a process for creating one or more sealed chambers between flat supporting elements interlinked by struts in a gasket.

2. Related Art

The commonly known method of interlinking supporting frames in a gasket involves the use of centrally positioned stamped struts. The sealing lips that create the sealed chamber extend beyond the struts both above and below. Because, for the sake of stability and for practicality of manufacture, there are limits to how thinly the struts can be dimensioned, the danger arises that the sealing lips will be excessively compressed if thin supporting elements are involved. Hence the current method is incompatible, as a practical matter, with the use of thinner supporting frames.

U.S. Pat. No. 5,267,740 introduced a metal cylinder-head gasket that incorporates auxiliary seals are crafted with dovetailing stamped areas that allow for a connection between the material of the supporting frames and the material of the auxiliary seal. The auxiliary seal is given a profile that extends across its own margin and the margin of the surrounding material of the supporting frames. This method of insuring tightness involves a very expensive manufacturing process.

### SUMMARY OF THE INVENTION

The present invention proposes, on the one hand, a process for shaping the struts between supporting elements in such a way as to prevent excess compression of the sealed chamber(s). On the other hand, it makes available a gasket with an optimized strut structure and insures optimized binding of the sealed chamber to the supporting elements.

This purpose of the invention is achieved via a manufacturing process that produces one or more sealed chambers between flat supporting elements interlinked by struts in a gasket, such that the struts are thinner than the cross-section of the supporting elements and have staggered, facing embossed areas; and such that each of the sealed chambers is situated toward the margins of the supporting elements.

The purpose is also achieved by means of a gasket, composed of several supporting elements interlinked by struts, in which the space between the supporting elements, including the struts, is formed out of an elastomer material so as to create at least one sealed chamber, while the struts have staggered, facing embossed areas.

It is recommended that the proposed gasket be constructed with metallic supporting frames and that these be interlinked by means of terraced embossed struts. The struts should preferable be embossed from above on one side and from below on the other side. The embossing should be staggered. Thus each strut will have at least one upper embossed component and at least one lower embossed component, the two embossed components being linked by a connection strut. The depth and width of the embossing can be adjusted according to the thickness of the supporting elements, so as to accommodate differing application situations. The connection strut between the separate embossed components insures that the struts will be stable at the embossed areas.

This approach makes it possible to divide the sealing contour in the area of the struts. The upper sealing-lip contour extends across the upper embossed area, while the lower sealing-lip contour extends across the lower embossed areas. The available open space in the sealed chamber is thus increased.

The proposed gasket affords the following advantages:
use of thinner supporting elements than heretofore (materials saving);
increased variety of strut and profile geometry, thanks to the staggered geometry of the sealing area;
embossing of struts all the way to the periphery is not obligatory;
available open space between the sealing lips is increased in the area of the struts;
the struts are fixed in place by the connection strut between the two embossed areas.

### THE DRAWINGS

The proposed gasket is illustrated by means of the sample realization shown in the drawings as follows:

FIG. 1 illustrates a section of a gasket;

FIG. 2 is an enlarged fragmentary detail of FIG. 1, showing the supporting elements with embossed studs;

FIG. 3 is an enlarged fragmentary detail of FIG. 1, also showing parts of the sealed chamber;

FIG. 4 is a top view of the sealed chamber shown in FIG. 3;

FIG. 5 is a bottom view of the sealed chamber shown in FIG. 3; and

FIG. 6 is an enlarged cross-section of FIG. 4 alone line A-A.

### DETAILED DESCRIPTION

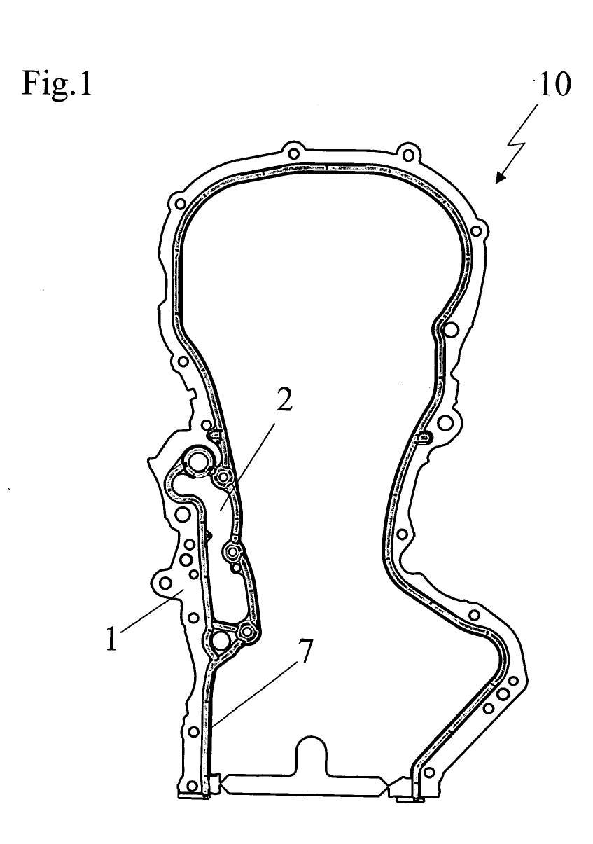

FIG. 1 shows a section of gasket 10 from above. Inner and outer supporting elements 1 and 2 are visible, as is a sealed chamber 7.

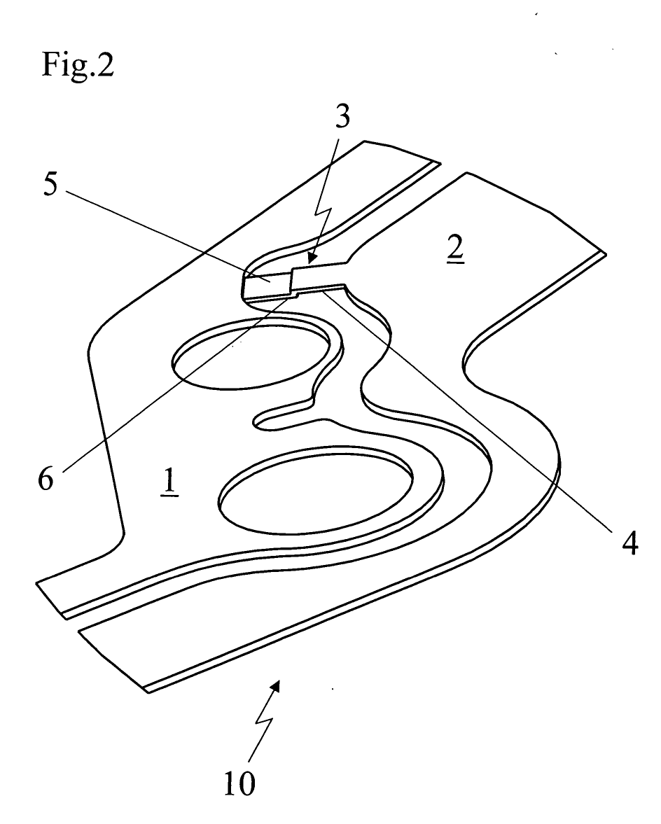

FIG. 2 is a diagrammatic sketch of two metallic supporting elements 1 and 2 linked by strut 3. Each strut 3 includes a first embossed component 4, linked to supporting element 2, and a second embossed component 5, linked to supporting elements 1. Embossed areas 4 and 5 are linked by means of a connection strut portion 6 to form a single unit. FIG. 2 shows only one strut 3, although the gasket 10 between the supporting elements 1 and 2 incorporates a number of such struts 3. The depth and width of the embossing in embossed areas 4 and 5 of strut 3 can be adjusted according tot he required thickness of the supporting elements.

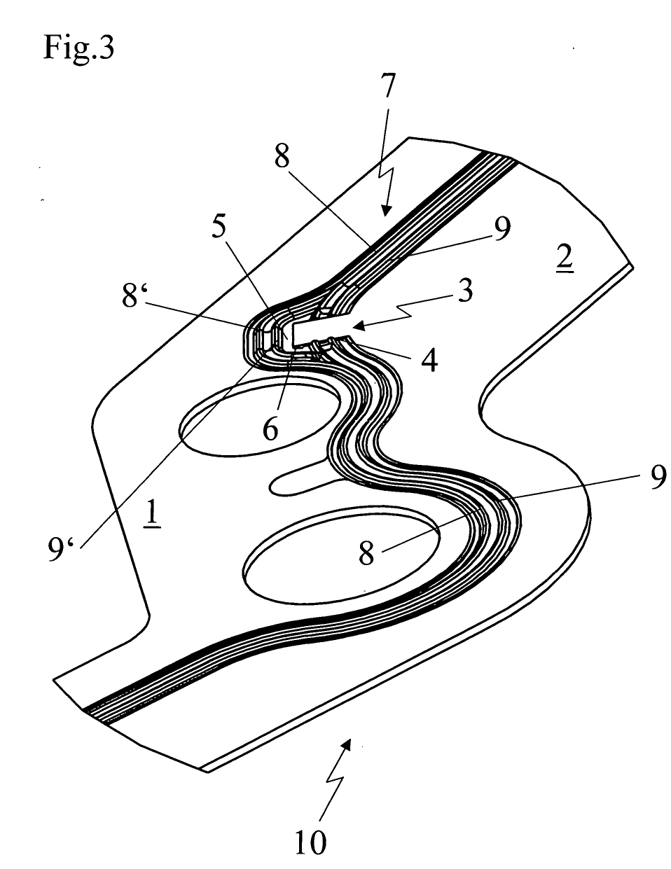

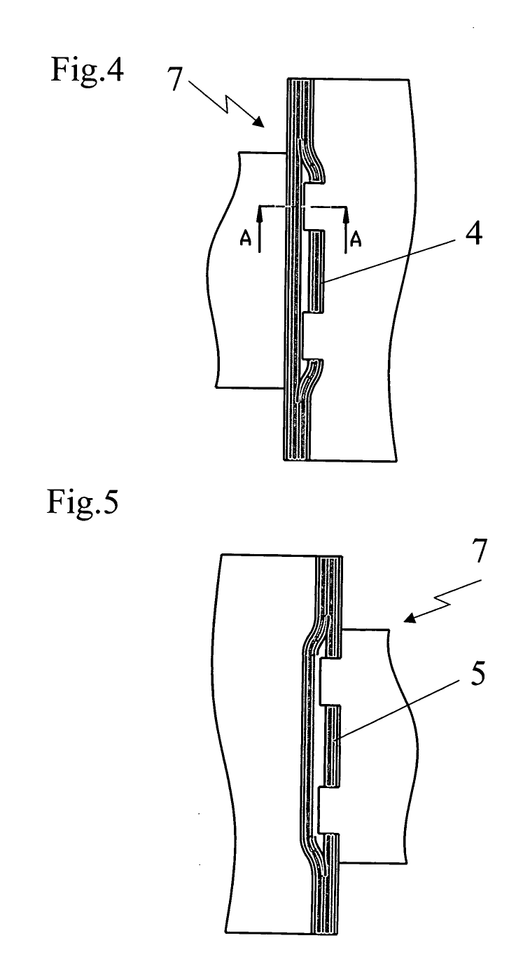

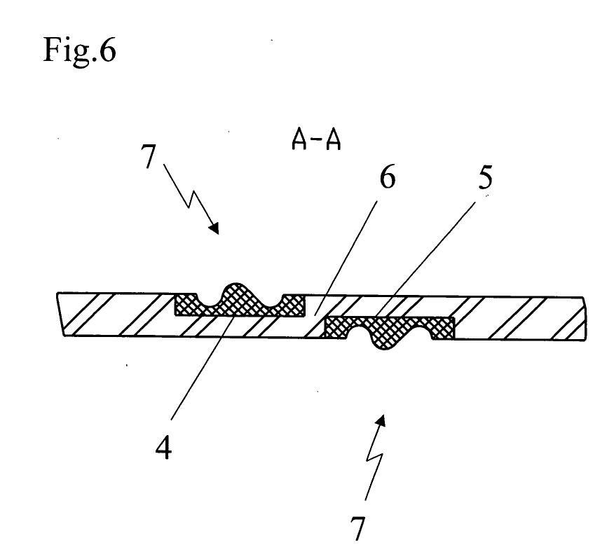

FIG. 3 is a view like FIG. 2 in which a sealed chamber 7 is visible and includes several sealing lips 8, 9, 8′ and 9′. Strut 3 is visible along with connection strut portion 6 linking embossed areas 4 and 5. Here, sealing lips 8 and 9 continue across the back of embossed area 4, whereas in embossed area 5 they terminate at strut 3, where sealing lips 8′ and 9′ are formed. FIGS. 4 and 5 show the layout of the sealed chamber 7, respectively from above and below. Embossed areas 4 and 5 are visible. FIG. 6 shows a cross-section of FIG. 4 along line A-A. Embossed areas 4 and 5 are visible along with connection stud 6 and the sealed chamber 7 that is encompassed between embossed areas 4 and 5.

Obviously, many modifications and variations of the present invention are possible in light of the above teachings. It is, therefore, to be understood that within the scope of the appended claims, the invention may be practiced otherwise than as specifically described.

1. Process for creating at least one sealed chamber between flat supporting elements interlinked by studs in a gasket, such that the studs are thinner than the cross-section of the supporting elements and have staggered, facing embossed areas; and such that each of the sealed chambers is situated toward the margins of the supporting elements.

2. Process as in claim 1, whereas at least one upper embossed component and at least one lower embossed component, the two embossed components being linked by a connection stud that holds them apart at a specified distance.

3. Gasket composed of several supporting elements interlinked by studs in which the spaced between the supporting elements, including the studs, is filled with an elastomer material out of which at least one sealed chamber is formed, while the studs have staggered, facing embossed areas.

4. Gasket as in claim 3 wherein each stud has at least one upper and one lower embossed component, such that the separate embossed components are linked by means of a connection stud of specified thickness so as to form a functional unit.

5. Gasket as in claim 3 wherein the depth and/or width of the embossing in the embossed areas are uniform.

6. Gasket as in claim 3 wherein the depth and/or width of the embossing in the embossed areas is not uniform.

7. A method of fabricating a sealed chamber in a gasket, comprising:
preparing the gasket with laterally spaced flat support elements of predetermined thickness that are interconnected by at least one strut bridging the spaced between the support elements;
embossing the at least one strut from opposite sides to form oppositely facing laterally staggered embossed areas that are recessed in relation to the adjacent support elements; and
introducing an elastomer material to the spaced between the support elements.

8. The method of claim 7 wherein the at least one strut is formed to be essentially co-planer with the adjacent support elements on a surface directly opposite that of the embossed areas.

9. The method of claim 7 wherein the elastomer is extended across the embossed areas.
